(19) United States
(12) Patent Application Publication
(10) Pub. No.: US 2011/0106653 A1
(43) Pub. Date: May 5, 2011

(54) MERCHANDISE DISPLAY SYSTEM, APPARATUS AND METHOD

(75) Inventor: Joseph Hyman Wein, Highland Park, IL (US)

(73) Assignee: FANTASY DIAMOND CORPORATION, Chicago, IL (US)

(21) Appl. No.: 12/849,148

(22) Filed: Aug. 3, 2010

Related U.S. Application Data
(60) Provisional application No. 61/273,450, filed on Aug. 3, 2009.
(60) Provisional application No. 61/310,111, filed on Mar. 3, 2010.

(51) Int. Cl. G06Q 30/00; A47F 3/00; E05B 65/52; H04N 7/18

(52) U.S. Cl. 705/26.8; 312/114; 312/7.2; 705/27.1; 345/173; 348/143; 348/E07.085

(57) ABSTRACT

The display apparatus of the invention is a display case combined with an electronic display for displaying merchandise items such as jewelry both physically and electronically. The electronic display of the merchandise items in the display case includes interactive features, as for example access to a website for purchasing the merchandise items. Where the merchandise items are valuable, such as jewelry, the merchandise items in the display case may be facsimiles of the actual merchandise for sale, so that customers may open the display case without a sales person.

### CROSS-REFERENCE TO RELATED APPLICATIONS

This application claims priority under 35 U.S.C. §119(e) to U.S. Provisional Application 61/310,111 filed on Mar. 3, 2010 and U.S. Provisional Application 61/273,450 filed Aug. 3, 2009,

### FEDERALLY SPONSORED RESEARCHER DEVELOPMENT

N/A

### BACKGROUND OF THE INVENTION

1. Field of the Invention

The invention relates to the display of merchandise, for example jewelry, and in particular to the display of jewelry in combination with access to interactive electronic display of information related to the merchandise, as for example on an internet website.

2. Background

Traditionally, merchandise items of high value and small size, such as jewelry, watches and the like, were kept in inventory at retail outlets, in order that the items be available to customers for manual inspection. This in turn necessitated a high investment in both inventory and security. Items were directly displayed to customers in display cases that could only be opened by sales people from a sales person's side of the display case. A customer could not directly access the merchandise without a sales person, and could not find out information about the item without a sales person.

### SUMMARY OF THE INVENTION

The display apparatus of the invention is a display case combined with an electronic display for displaying merchandise items such as jewelry both physically and electronically. The electronic display of the merchandise items in the display case includes interactive features, as for example access to a website for purchasing the merchandise items. Where the merchandise items are valuable, such as jewelry, the merchandise items in the display case may be facsimiles of the actual merchandise for sale, so that customers may open the display case without a sales person. Hence a shopper may manually inspect an item and also learn relevant information about it without the involvement of a salesperson.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a perspective view of a first embodiment of the present invention.

FIG. 2 is a perspective view of the second embodiment of the present invention.

FIG. 3 is a perspective view of a third embodiment of the display case of the present invention.

FIG. 4 is a perspective view of the third embodiment of the present invention as assembled.

FIG. 5 is a perspective view of the third embodiment of the present invention as installed.

FIG. 6 is a perspective view of the third embodiment of the present invention as installed with the display case open.

FIG. 7 is a block diagram of the system of the present invention.

FIG. 8 is a block diagram of the databases of the system of the present invention.

FIG. 9 is a flow chart of a set up routine.

FIG. 10 is a flow chart of a set up routine.

### DETAILED DESCRIPTION

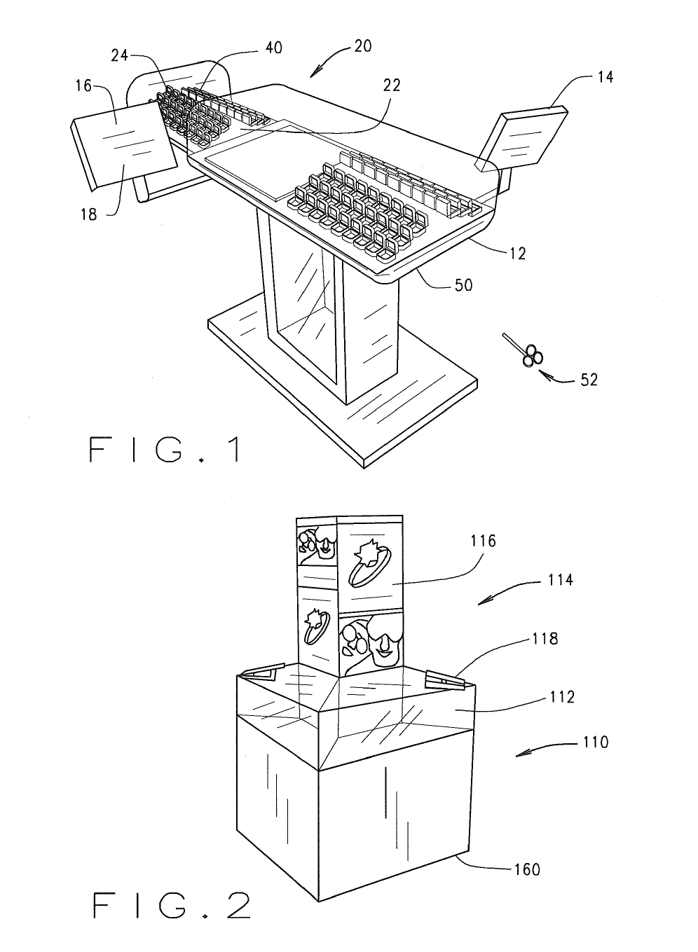

Referring now to the drawings wherein like reference numbers refer to like elements, FIG. 1 is an exemplary embodiment of the display case with electronic display of the present invention. Display module 10 is comprised of a display case 12 combined with an electronic display(s) 14. In the depicted embodiment, the electronic display(s) 14 are attached to the display case 12. The electronic display(s) 14 may include a display screen 16 on which may be displayed representations of and information about merchandise items for sale.

In the depicted embodiment, the display case is a comfortable height for customer viewing, for example and without limitation in the range of 40-45″.

The electronic display(s) 14 may also include a keypad or touch screen component 18. Through the interactive element 18, i.e., a keypad or touch screen, a customer may access and operate at least one interactive feature relative to merchandise items for sale. Interactive features as used herein shall include interaction between a customer and a computer relative to the merchandise that is for sale. In one embodiment, this would include access to an internet web site offering the merchandise items for sale. Hence, the interactive features of the present invention would include without limitation features such as a shopping cart, a wish list, an order placement, page, links to additional information about the merchandise for sale, links to related merchandise, e-mail capacity, sharing links to a merchandise item with others, customer rankings, reviews by other customers, shipping rate lookups, remote payment information and capability, location of the item in a store, and the like.

Further depicted in FIG. 1 is an embodiment of the present invention wherein a display case 12 may be opened via opening 20. In the depicted embodiment, opening 20 is comprised of a slide 22. Any conventional means of opening a display case is within the scope of the present invention. With the present invention, however, the display cases may be advantageously opened by the customer. While prior art retailing and display of valuable items such as jewelry, watches and the like have traditionally not made the merchandise directly accessible by the customers for security reasons, the present invention allows for direct customer access while maintaining an adequate level of security by replacing the actual merchandise items of higher value with facsimiles of them. The facsimiles or replicas 40 are of lesser value. For example, in the case of jewelry, diamond rings may be replaced by rings having cubic zirconia as the stones. Other theft prevention devices may also be used with or instead of replicas 40, including but not limited to, chains, video cameras, magnetic tags, wireless sensors or the like.

As will be described more fully below, the contents of a display case 12 may be advantageously organized into trays 42. The trays 42 may hold a preconfigured array of replicas 40 of items for sale.

In one embodiment of the present invention, the display case may be locked 50 but accessed by a customer through the use of a key 52. The key 52 may be dispensed by a sales person. The key 52 may be physical or electronic. After giving a customer a key, the sales person would no longer be needed to supervise the customer inspection of the merchandise, although the sales person would still be available should the customer want help.

FIG. 2 depicts an alternate embodiment of the present invention. In FIG. 2, display module 110 includes display cases 112 and electronic display apparatuses 114.

The electronic display apparatuses may include a key pad or touch screen 118, together with displays 116 that may be contiguous with or, as depicted, nearby the key pad or touch screen 118. The display screen 116 may, in response to user entries into the touch screen or key pad 118 electronically display depictions of and further information about the merchandise items for sale. At least one of the merchandise items electronically displayed may be the same as at least one of the merchandise items displayed by facsimile 40 within display case 112. As before, interactive features may be accessed through touch screen or key pad 118 and viewed on display 116. A single module 110 may include multiple display cases 112 so that multiple customers may access the replicas 40 simultaneously. Again, each display case 112 may be accessed by a customer.

The embodiment depicted in FIG. 2 may be palletized. That is, the module may be a self-contained unit that may be placed, as for example by a forklift, at any desired position, for example within a mall, a warehouse club or at a temporary event such as a county fair. Additional modules 110 may be installed in a standard retail outlet to expand capacity temporarily, as before holidays. The electronic components may be powered by standard AC outlets or, in the alternative, battery powered.

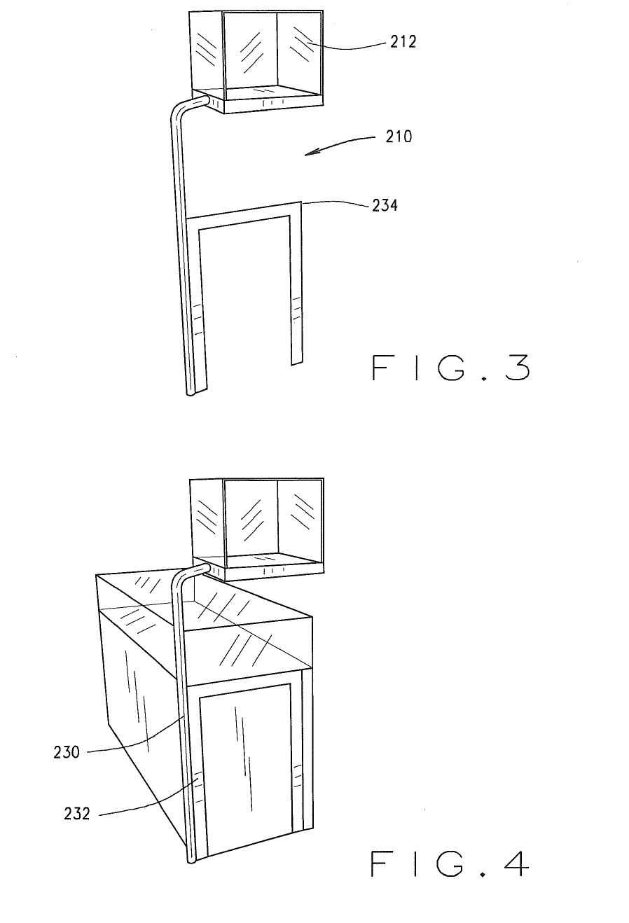

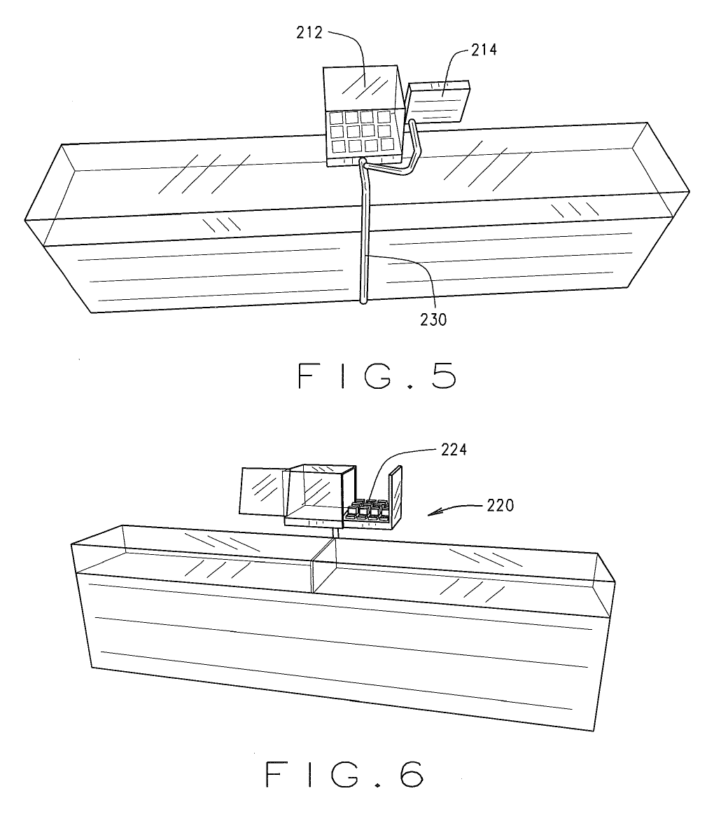

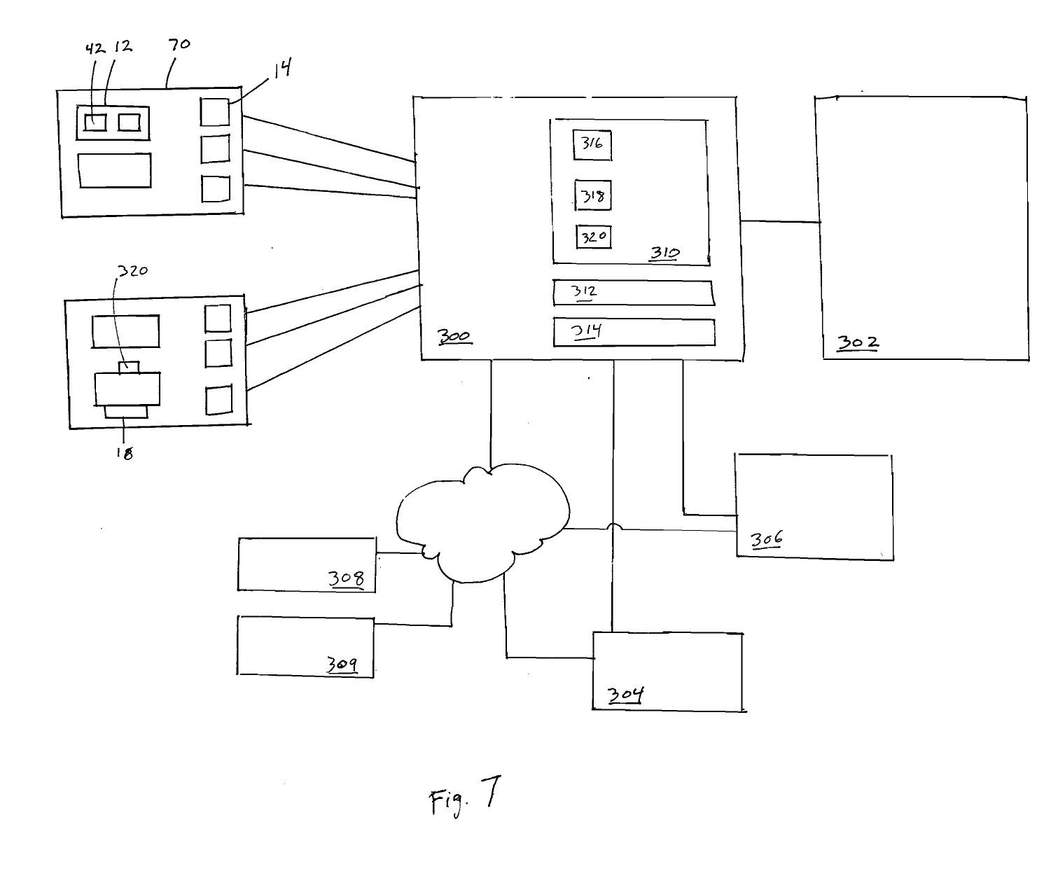

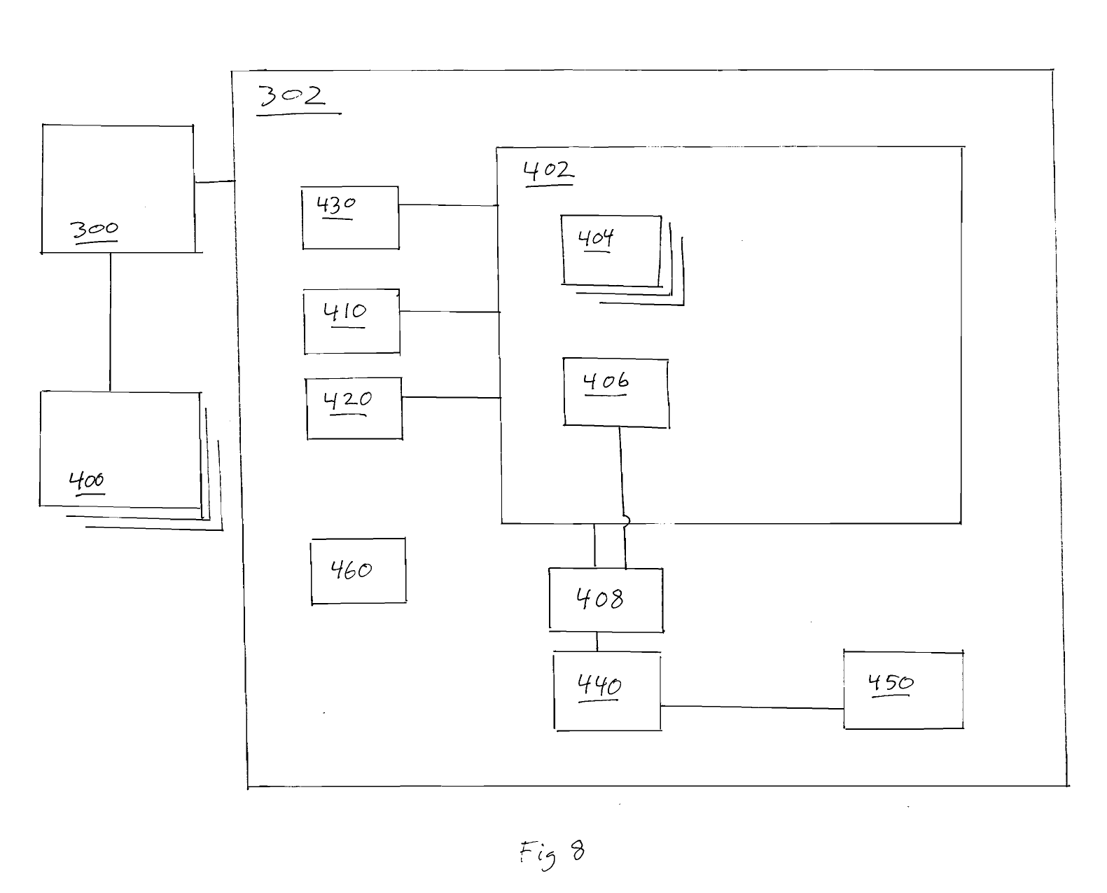

As depicted in FIGS. 3, 4, 5 and 6, an alternate display module 210 may be comprised of a display case 212 and an attached electronic display 214 that is designed to be assembled with pre-existing standard display cases. Such modules may include a stand 230 and a mounting element 232 constructed and arranged for fixation with a standard counter. An adjustable extension or tensioner 234 may be included to facilitate a secure assembly with the pre-existing standard display cases. The display case 212 may be mounted on a pole 236, which may be telescopic. As in the previous embodiments, a display case may be opened with any standard display case opening device 220 in order to display facsimile merchandise items 224.

As will be readily appreciated by those with skill in the display and retailing arts, prospective purchasers of a small, valuable item such as jewelry may advantageously have their two major concerns and purchasing decisions addressed with the present invention, without the intervention of sales staff. That is, the customer may handle and manually inspect the merchandise by opening the display case. Because the merchandise items are available to the customer in facsimile only, the security concerns necessitated by the prior art systems are eliminated. The prospective customer may also make inquiries in order to find out information relative to their purchasing decisions, for example, availability, price, sizing alternatives and the like, through the electronic display and its links with data bases having the relevant information. These two proven consumer preferences are accommodated with the system, method and apparatuses of the present invention while advantageously minimizing previously burdensome inventory and security costs.

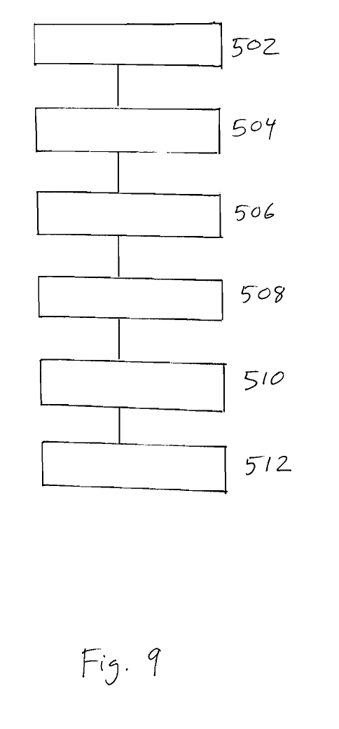

The system, apparatus and method of the present invention advantageously combines the appealing elements of electronic catalog shopping primarily familiar through online shopping on web pages with the traditional elements of “bricks and mortar” retailing techniques that provided for inspection the actual physical objects. These heretofore incompatible systems are reconciled in the following manner. FIG. 7 is the block diagram of the system of the present invention. In it stores 70 or other customer access facilities include one or more displays 10 as described above. Each display case 12 may have one or more trays 42 which are accessible by the customer and on which are provided for manual inspection replicas 40 of the merchandise items for sale.

Whether attached to the display case 12 or independently provided, electronic display devices 14 are associated with the display cases 12. In one embodiment, the electronic display devices 14 are provided by store personnel at the store 70. The electronic display devices 14 may include wireless communication devices as for example PDAs, cell phones, iPhones®, iPads™ and the like. In one embodiment iPads™ are used.

In the system of the present invention each electronic display device 14 has a unique device identification (“UDID”). In the present invention, each UDID is uniquely associated with the display modules 10 in a particular store 70. More particularly, each electronic display device 14 associated with a particular store 70 will be further associated with each unique display case 12 of merchandise items on display in a given store 70.

The electronic devices 14 are each in operative communication with a server 300. The server 300 computer(s) is further in operative communication with the database 302 and with a system administrator's interface and control unit 304. The server 300 is configured to perform functions including initiating a shopping session 310, set up routines 312 and checkout routines 314. The server 300 is further configured to execute other functionalities as described herein below.

The initiation of a shopping session 310 may be initiated in at least one of the following three manners. First, a browse function 316 allows a customer to access an entire catalog of merchandise items available for sale, whether those items appear in replicate format in the particular store 70 or not. This shopping session initiation functions in a known manner for other electronic catalogs such as for example online catalogs. The catalog items may be electronically displayed through display 18 on either the electronic display device 14 or on the display case 12, as seen in FIG. 2 at 116.

A second shopping session initiation routine is a search 318. In the search routine, a customer enters into fields provided on the electronic display device 14 any of a number of search parameters which may be typed in the search field or checked off of preconfigured displayed field of choices. For example, in a jewelry store the choices would include item type, such as rings, earrings, necklaces or bracelets, price ranges, types of stone and the like. Shopping session initiation routine 318 would then search database 302 for items responsive to the search request and return from database 302 a display of those items at electronic display 16. In one embodiment, the items responsive to the search could be prioritized to show the items that are cross checked by the server 300 to correspond to those items on display at that particular store 70.

A third shopping session initiation route 320 would be to search by tray. In this routine, a customer at a display module is looking at a particular tray 42 having a particular array of merchandise item facsimiles 40 and is interested in one or more of them. The electronic display device 14 has a prompt, such as a touch screen button, that can be selected for further display of a particular tray 42 having particular items 40. The shopping session initiation routine 320 thereupon recalls from database 302 a preconfigured body of information, data and options associated with a particular tray of items 42 and displays them to the customer on electronic display 18. For example, an image of the particular tray 42 may be displayed on electronic display device 14 as a touch screen, allowing the customer to just touch the item of interest to get the relevant data about it. What is stored and displayed by this routine is more fully described herein below.

Set up routine 312 allows a system administrator to use administrator interface 304 to pre-configure the aspects of the system described herein, including for example what trays are associated by UDID with the actual physical replicas 40 displayed on particular trays 42 in particular display modules 10 at particular stores 70. The administrator interface 304 may be directly associated with the server 300 or, in the alternative, may access the server 300 through network connectivity, such as the internet through a web page configured for dedicated use by the administrator, with appropriate log-ins and security functions.

The server 300 may be further configured to execute these additional features. A customer may connect with other interested parties, such as for example a spouse, from the electronic display device 14. This may be by e-mail 308. Accordingly, the server 300 and electronic display device 14 are configured to enable e-mailing, with attachments such as depictions of a particular merchandise item for sale, and to send such an e-mail, with comments, from the customer using the electronic display device 14 at the store 70 to a recipient whose e-mail address would be entered by the customer.

The server 300 may facilitate access by the customer through the electronic display device 14 to various internet shared content sites, such as a social networking site 309. Once again, particular information, such as images may be loaded on to the social networking site 309 through the server 300 by input from the customer with electronic display device 14.

Towards this end, the display module 10 may further provide digital cameras 320 associated with or attached to the display cases 12. With these cameras, a prospective customer may try on a facsimile of the merchandise item for sale 40, present themselves to the camera 320 and see on the electronic display 16, 116 a picture of themselves wearing the jewelry for sale. This image may then be shared through the electronic display device 14 and the server 300, either with an e-mail recipient 308 or be loaded onto a social networking site 309.

Server 300 may also be configured to execute purchases. The purchasing routine 314 may include direct sales from the owner operator of the system of the present invention to the customer. This would be a simple matter of receiving a payment option selected by the customer as for an example with known online payment systems or credit cards. In the alternative, a sale may be made through a sales person at the store 70. In either case, the merchandise item corresponding to the selected item would be identified and a shipping order generated, according to shipping data stored in database 302 and shipped to a physical address entered by the customer through electronic display device 14.

However, the system of the present invention may accommodate display marketing and sales of merchandise items through stores 70 that are owned and operated by entities different than the administrator of the present invention. For example, the system of the present invention accommodates sale of merchandise through installation display modules at pre-existing stores 70 such as chain stores. It may be the preference of the owner of the store 70 that purchases of merchandise items within that store's facility, or purchases of particular merchandise items in that store's inventory, be purchased through a computer network operated by that store. This may be a proprietary LAN or an internet web site. Accordingly, the check out routine 314 may, in the alternative, be configured to direct a purchase order through server 300 to a networked computer purchasing system 306. This may be through direct communication through the networked retailer check out computers 306, or, alternatively, through a shared network such as the internet, directing the purchase to the retail store's web site 306. Having communicated the purchase order, server 300 thereafter turns over check out processes such as payment to the system of the retail store's web site 306. Records of such purchases may be stored in a memory in database 302 for possible use in marketing research or billing for such sales to accommodate a contractual arrangement between the store owner and administrator of the present invention.

As depicted in FIG. 8, the database 302 is configured to organize and maintain the following data. First, of course, all products comprising merchandise items for sale are stored 402. Each product will have a variety of data stored in association with it. One of these data items will be inventory data, including the number and inventory and in which particular warehouse 400 the item is stored. Further product data will include straightforward product information 404 such as price, sizes in which it is available, and the like. Further product data would include related merchandise items, for example matching jewelry. Further product data may include product configurability options 406, which may be interactive and provide for customer input of preferences, which are in turn stored in memory 408. In the case of jewelry, this may for example include different types of metals in which a particular item is available, different types of stones that may be set in the jewelry item, and the like.

The database 302 will also include supplier data 410 and retailer data 420. With regard to supplier data, information of particular importance may include particular times at which a particular merchandise item of a particular supplier is offered through the system of the present invention, and associated service fees for that item's presence on the system. Supplier data may also include other merchandise item data particular to that supplier such as discount or sale information or data corresponding to other financial arrangements between the supplier and the administrator of the system of the present invention. Supplier information may be associated in memory with particular items from that supplier.

With regard to retailer data 420, information that may be of particular importance would include whether or not particular items need be purchased through that retailer's proprietary check out and purchasing systems as described above. Further, particular information such as seasonal installations of modular displays may be stored.

In the depicted embodiment of the system, method and apparatus of the present invention, organization of the merchandise items for sale corresponding to the displays of facsimiles 40 of those items in the display cases 12 is stored. Accordingly, tray arrays 42 that may be observed on location and manually inspected by a customer are preconfigured to correspond to an electronic display of that tray 42 and the items on it as configured by the administrator and stored in the database portion 430. Through this display of the tray data, a shopping session may be initiated and from the tray particular merchandise items for sale may be clicked on or touched by the customer so that the system next accesses in the database and displays a particular product information 404, 406.

As will be apparent to those of skill in the art, supplier data and retailer data would most likely not be directly displayed to a consumer on the display device 16, although storing this data is necessary to maintain the previously agreed upon relationship between the supplier and the administrator of the system of the present invention and particular retailers and the administrator of the system of the present invention.

Further data that may be stored within the database 302 may include a specific database particular to an individual customer 440, initiated by that customer through the use of the electronic display apparatus 14. The contents of this specific database would be that loaded by the customer, which may include, at the customer's election, information such as e-mail addresses, wish lists, preferences for configurations and merchandise items, email addresses for the customer or related parties, social networking site access data and the like. A separate database may be organized and maintained for statistical analysis of marketing and/or for initiating contacts such as sale notices to participating customers 450.

A separate database may be maintained for shipping data 460 including, for example and without limitation, costs to various locations, for various sized items and through various shipping services.

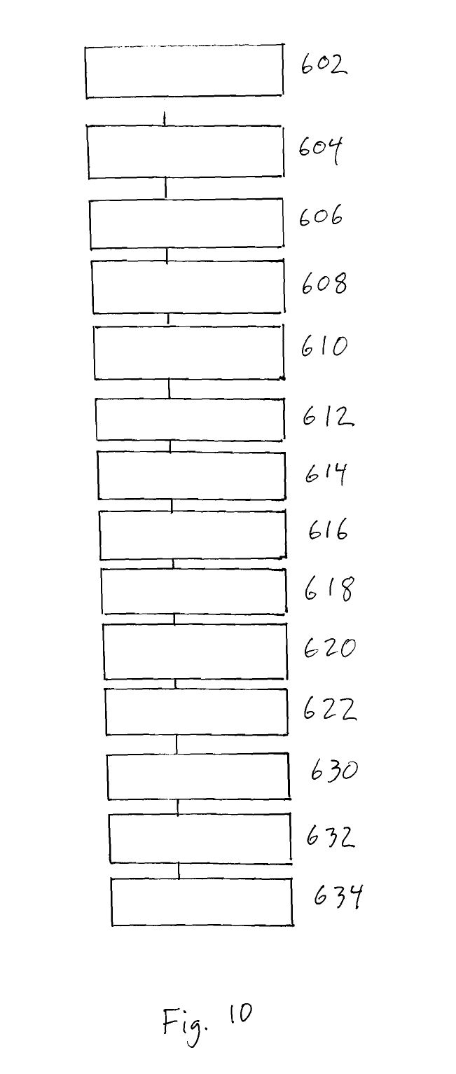

As depicted in FIG. 9, a set up routine flow chart, through the administrator interface 304, may establish one or more installations at a particular store or chain of stores as follows. A plurality of merchandise items to be sold is entered in step 502 in database 402. Supplier data is entered 504 in the event that merchandise items from a supplier other than the administrator of the present invention are to be sold. Retailer data is entered 506 as may be required by arrangements for installation of the displays at particular stores 70 or chains of stores. Any retailer requirements for particular check out routines are configured 508.

Tray displays 42 of merchandise item replicas are organized 510 to correspond to electronic memory 430 of those items. Tray display databases are entered and configured in database 430, links from a tray display memory are established 512 to each of the product specific memories 404 for which facsimiles are displayed on that particular tray 42 and electronic displays are to be available.

Shopping routines proceed as depicted in FIG. 10. A customer is provided 602 an electronic display device 14 having a UDID. In a preferred embodiment, this de vice is provided by personnel at the store 70. Next, a customer selects 604 a shopping session initiation option. If the option is to browse, an entire electronic catalog is displayed 606. If the option is to search, search fields are displayed 608. Upon entry of customer selections in the search fields, the product database is searched 610 for responsive merchandise items and they are displayed 612 at the electronic display device 16. If a search by tray is selected 614, the electronic display device 14 may have a tray identification button selected. In the alternative, opening a display case having a particular tray 42 may automatically initiate a tray selection shopping section routine. An electronic display of the items on the selected tray is displayed 616. Having selected a tray, a customer would next select a particular item 618 displayed on that tray. The system then retrieves 620 from memory a link to the data relevant to this particular merchandise item and displays the data. In the event interactive options are selected 622 by the customer, such as ordering, placement on a wish list, configuration options, sharing or e-mailing, the server 300 receives the selections through the electronic display device 14 and executes them. In the event of purchases made, a purchase order is generated 630 and billing options are displayed and executed according to customer selection 632. In the event that the display is at a retailer having its own check out routine, the check out routine for that retailer is initiated 634.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A display apparatus comprising:
a display case containing merchandise items;
said display case merchandise items being facsimiles of merchandise items for sale;
an electronic display associated with said display case, said electronic display having electronically displayed merchandise items, at least one of said electronically displayed merchandise items being the same as at least one of said display case merchandise items; and
said electronic display having at least one interactive feature.

2. A display apparatus comprising:
a display case containing merchandise items;
an electronic display attached to said display case, said electronic display having electronically displayed merchandise items, at least of one of said electronically displayed merchandise items being the same as at least one of said display case merchandise items; and
said electronic display having at least one interactive feature.

3. A method of providing self help shopping to potential buyers of high value merchandise items comprising:
providing a customer accessible display;
providing a replica of a merchandise item for sale in said display, said replica having a value lower than the actual merchandise item for sale; and
providing a customer operable electronic ordering device to receive and execute a purchase order for one of the actual merchandise items for sale.

4. The display apparatus of claim 1 further comprising:
said electronic display being attached to said display case.

5. The display apparatus of claim 1 further comprising:
said display case being configured to be opened by a customer without a sales person.

6. The display apparatus of claim 5 further comprising:
said opening being with a store provided key.

7. The display apparatus of claim 1 further comprising:
said electronic display having a unique device identification.

8. The display apparatus of claim 7 further comprising:
said electronic display having a unique device identification being associated in a memory with an array of items in a particular one of said display cases.

9. The display apparatus of claim 8 further comprising:
a database of items for sale, said database being searchable according to said array of items in a particular one of said display cases.

10. The display apparatus of claim 1 further comprising:
said electronic display activating an electronic display of products for sale on said electronic display corresponding to an array of items for sale arranged in a particular one of said display cases.

11. The display apparatus of claim 10 further comprising:
a memory with a plurality of arrays of items for sale being stored separately in said memory, each of said stored memories of arrays of items for sale corresponding to each of a plurality of items for sale displayed physically in each of a plurality of said display cases.

12. The display apparatus of claim 1 further comprising:
said interactive features including a shopping cart, a wish list, an order placement, page, a link to additional information about the merchandise for sale, a link to related merchandise, an e-mail capacity, a sharing of links to a merchandise item with others via computer network, a customer ranking, a review by other customers, a shipping rate lookup, a remote payment capability, an individual customer data storage and a location of the item in a store.

13. The display apparatus of claim 1 further comprising:
said electronic display device having a user interface.

14. The display apparatus of claim 13 further comprising:
said user interface being a touch screen having said items for sale. displayed thereon.

15. The display apparatus of claim 13 further comprising:
said user interface and said electronic display being on the same device.

16. The display apparatus of claim 1 further comprising:
said display case being modular and moveable.

17. The display apparatus of claim 9 further comprising:
a correspondence of said array of items in said memory with said array of items in said particular one of said display cases is configurable by a system administrator remote from a server accessing said database.

18. The display apparatus of claim 1 further comprising:
a database of all products for sale, said database being organized to link to each of a plurality of items for sale stored in a memory of an array of items for sale.

19. The display apparatus of claim 1 further comprising:
a camera attached to said display case, said camera being in operative communication with said electronic display such that an image of a customer may be displayed on said electronic display.

20. The display apparatus of claim 1 further comprising:
a payment routine, said payment routine being executable directly through a server in operative communication with said display apparatus or through a third party maintained site on a computer network, one of said payment execution options being associated in memory with each of said plurality of items for sale.

21. The display apparatus of claim 1 further comprising:
a database, said database comprising in association with each of a plurality of items for sale at least one of a shipping data memory, a related products memory, a supplier data memory, a retailer memory and an individual customer data memory.

22. A display apparatus comprising:
a display case containing merchandise items;
said display case merchandise items being facsimiles of merchandise items for sale;
an electronic display associated with said display case, said electronic display having electronically displayed merchandise items, at least one of said electronically displayed merchandise items being the same as at least one of said display case merchandise items;
said electronic display having at least one interactive feature;
said display case being configured to be opened by a customer without a sales person;
said electronic display having a unique device identification being associated in a memory with one of a plurality of arrays of items for sale being stored separately in said memory, each of said stored memories of arrays of items for sale corresponding to each of a plurality of arrays of items for sale displayed physically in each of a plurality of said display cases; and
a payment routine, said payment routine being executable directly through a server in operative communication with said display apparatus or through a third party maintained site on a computer network, one of said payment execution options being associated in memory with each of said plurality of items for sale.
